(19) United States
(12) Patent Application Publication
(10) Pub. No.: US 2008/0120109 A1
(43) Pub. Date: May 22, 2008

(54) SPEECH RECOGNITION DEVICE, METHOD, AND COMPUTER READABLE MEDIUM FOR ADJUSTING SPEECH MODELS WITH SELECTED SPEECH DATA

(75) Inventor: Ing-Jr Ding, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/744,673

(22) Filed: May 4, 2007

(30) Foreign Application Priority Data
Nov. 16, 2006 (TW) 095142442

(51) Int. Cl. G10L 15/00

(52) U.S. Cl. 704/255; 704/E15.001

(57) ABSTRACT

A device, method, and computer readable medium for adjusting speech models with selected speech data are provided. The first determination module determines whether the keyword is valid. If so, the first computing module computes the adjustment weight according to the keyword, while the second computing module computes temporary models according to the keyword, designated speech model and speech models. The adjustment module weighs the speech models and temporary models according to the adjustment weight to update the speech models. As a result, the robustness of the speech models is improved.

This application claims the benefit of priority based on Taiwan Patent Application No. 095142442 fled on Nov. 16, 2006 of which the contents are incorporated herein by reference in its entirety.

### CROSS-REFERENCES TO RELATED APPLICATIONS

Not applicable.

### BACKGROUND OF THE INVENTION

1. Field of the Invention

The invention relates to a speech recognition device, a method, and a computer readable medium thereof; specifically, it relates to a speech recognition device, a method, and a computer readable medium thereof by using filtered speech data to adjust speech recognition models.

2. Descriptions of the Related Art

Operation interfaces between people and electronically manufactured equipments have becoming increasingly important; however, conventional operation interfaces involving electronically manufactured equipments have not yet been satisfactory. In addition, operation interfaces can be designed to be more user-friendly if language can be used to operate the equipments. For example, adding a speech recognition device to an electronically manufactured equipment allows the translation of language into serial instructions for operating the equipment. As a result, the operation of the electronically manufactured equipment is more convenient and valuable.

HMM (Hidden Markov Model) is a model often adopted in the field of speech recognition. An HMM speech model considers an input datum, such as a document, as a probability model. Each index (such as a word or a term) has a corresponding probably distribution in the HMM speech model. By using the HMM speech model, the content of an unrecognized document is decided according to the probability of the appearance of each of the indexes of the unrecognized document. To make speech recognition more reliable, speech data should be selected to adjust the HMM speech model so that speech signals of different users can be recognized. Hence, it is still important to find a way to select speech data for the adjustment of the HMM speech model.

FIG. 1 shows a diagram of a conventional speech recognition device 1 comprising a reception module 101, a determination module 102, a feature extraction module 103, a keyword extraction module 105, an adaptation module 107, a recognition module 109, and a database 108, wherein the database 108 stores a plurality of HMM speech models. The reception module 101 is configured to receive an original signal 100, wherein the original signal 100 may comprise a speech signal of a user or a background noise signal. After receiving the original signal 100, the reception module 101 sends the original signal 100 to the determination module 102 for determining whether the original signal 100 is a speech signal. If not, the recognition process is terminated. If so, the feature extraction module 103 extracts a featured speech signal 104 from the original signal 100. The featured speech signal 104 can be one or a combination of MFCCs (Mel-scale Frequency Cepstral Coefficients), LPCCs (Linear Predictive Cepstral Coefficients), and Cepstral of the original signal 100. The keyword extraction module 105 extracts a keyword speech signal 106 according to the featured speech signal 104. For example, the original signal 100 can be inputted by the user as “Please look for Wang, Jian-Ming.” The featured speech signal 104 would be the MFCC of the speech data “Please look for Wang, Jian-Ming”, while the keyword speech signal 106 would be the MFCC of “Wang, Jian-Ming”. After that, the speech recognition device 1 displays a message, such as a dialog, to ask the user to confirm whether the keyword speech signal 106 is correct. If so, the adaptation module 107 uses the keyword speech signal 105 to activate the HMM speech model stored in the database 108 that corresponds to the keyword speech signal 105. The activated HMM speech model will then be more similar to the user's speech. Finally, the recognition module 109 will recognize the next speech data according to the adapted database.

U.S. Pat. No. 6,587,824 discloses a method of adjusting the HMM speech model. The method manually selects the speech data to adjust the HMM speech model. If the number and the quality of the speech data are not good enough, the result derived from the adaptation module 107 will not be reliable. As a result, there will be a decrease in the accuracy of recognition. Furthermore, the method is unable to dynamically adjusts the HMM speech model. In other words, the drawbacks of the method come from the idea that all speech data have the same effect on all the HMM speech models.

According to the above descriptions, a conventional speech recognition device can not dynamically adjust the HMM models stored in the database, when the quality and the number of the speech signals are not good enough. In other words, no matter the lengths and the qualities of the original signals (i.e. the speech signal), there will be no difference in effects of them on the HMM speech models stored in the database. In addition, selecting the speech signal for the adjustment of the HMM speech models is done manually, so the cost of whole device increases. Hence, it is still a critical issue to create a speech recognition device which can automatically confirm the speech signal and dynamically adjust the HMM speech models in the database when the quality and number of speech signals are not good enough.

### SUMMARY OF THE INVENTION

One objective of this invention is to provide a speech recognition device. The device comprises a first determination module, a first calculation module, a second calculation module, an adjustment module, and a recognition module. The first determination module is configured to decide an appointed speech model according to a keyword speech signal wherein the appointed speech model is one of a plurality of speech models stored in a first database. The first determination module is also configured to determine whether the keyword speech signal is valid. The first calculation module is configured to calculate an adjustment weight according to the keyword speech signal if the keyword speech signal is valid. The second calculation module is configured to calculate a plurality of temporary models according to the keyword speech signal, the appointed speech signal, and the speech models if the keyword speech signal is valid. The adjustment module is configured to weigh the speech models and the temporary models to update the speech models according to the adjustment weight. The recognition module is configured to recognize a new speech signal according to the updated speech models.

Another objective of this invention is to provide a speech recognition method. The method comprises the following steps: deciding an appointed speech model according to a keyword speech signal; determining whether the keyword speech signal is valid, wherein the appointed speech model is one of a plurality of speech models stored in a first database; calculating a adjustment weight according to the keyword speech signal if the keyword speech signal is valid; calculating a plurality of temporary models according to the keyword speech signal, the appointed speech signal, and the speech models if the keyword speech signal is valid; weigh the speech models and temporary models to update the speech models according to the adjustment weight; and recognizing a new speech signal according to the updated speech models.

Yet a further objective of this invention is to provide a computer readable medium storing an application program to execute a method for speech recognition. The method comprises the following steps: deciding an appointed speech model according to a keyword speech signal; determining whether the keyword speech signal is valid, wherein the appointed speech model is one of a plurality of speech models stored in a first database; calculating an adjustment weight according to the keyword speech signal if the keyword speech signal is valid; calculating a plurality of temporary models according to the keyword speech signal, the appointed speech signal, and the speech models if the keyword speech signal is valid; weight the speech models and the temporary models to update the speech models according to the adjustment weight; and recognizing a new speech signal according to the updated speech models.

The invention is able to automatically select effective speech signals needed to adjust the models in the case that the quality and number of speech signals are not enough. Furthermore, the invention can improve the robustness of the adjustment of the models. In summary, the present invention is able to solve the two main problems faced by the conventional speech recognition devices: (1) bad adjustment result caused by few and bad speech signals and (2) high cost resulted from manual selection of the speech signals to adjust the models.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a conventional speech recognition device;

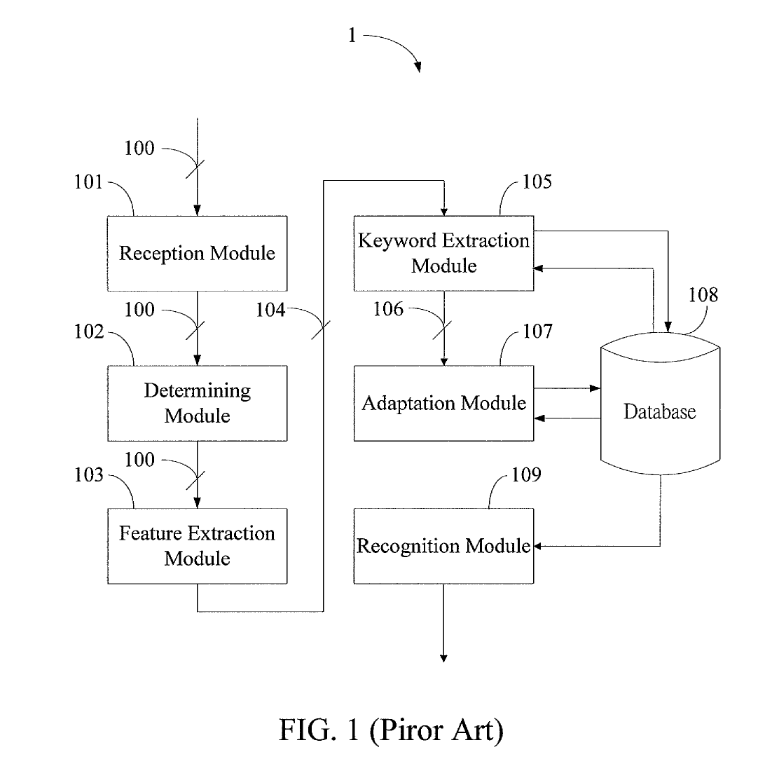

FIG. 2 is a schematic diagram of the first embodiment of the present invention;

FIG. 3 is a schematic diagram of the first determination module of the first embodiment;

FIG. 4 is a schematic diagram of extracting the frame from the keyword speech signal of the present invention;

FIG. 5 is a coordinate diagram of the present invention;

FIG. 6 is a flow chart of the second embodiment of the present invention; and

FIG. 7 is a further flow chart of the second embodiment of the present invention.

### DESCRIPTION OF THE PREFERRED EMBODIMENT

Support Vector Machines (SVMs) are usually used as a classifier. An SVM is based on the theory of the structural risk minimization of statistics. An SVM classifies a new input datum by a separating hyperplane. Specifically speaking, if the SVM model intends to determine whether an input datum was A, it would find out the SVM model of A from the SVM database. Next, the separating hyperplane of the SVM model of A is used to classify the input datum as A or not A.

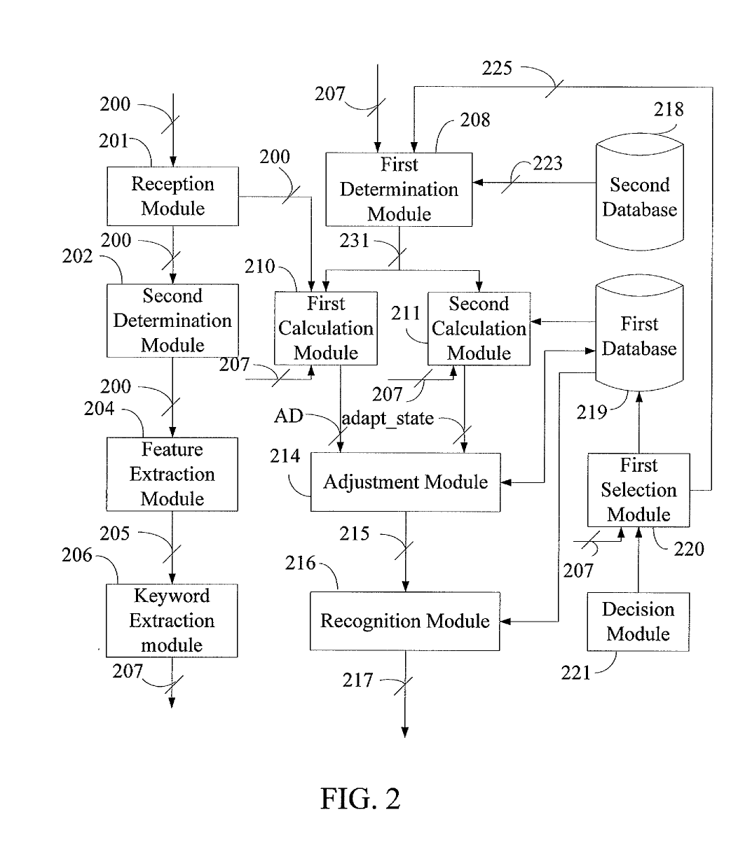

A first embodiment of the invention is shown in FIG. 2, which shows a speech recognition device comprising a reception module 201, a first determination module 208, a second determination module 202, a feature extraction module 204, a keyword extraction module 206, a first calculation module 210, a second calculation module 211, an adjustment module 214, a recognition module 216, a first selection module 220, and a decision module 221. The speech recognition device is connected to both a first database 219 and a second database 218. The first database 219 stores a plurality of HMM speech models, while the second database 218 stores a plurality of SVM determination models. The SVM determination models are generated according to the corresponding HMM speech models.

The speech recognition device of the first embodiment is configured to determine a speech signal comprising a human name. As an aside, HMM speech models and SVM determination models are generated according to human names. Each human name has its own HMM speech model and SVM determination model. The HMM speech models are explained at the first place. A Chinese name “ [symbol] ” (i.e. Wang, Jian-Ming) will be used for the explanation. The Chinese name “ [symbol] ” (i.e. Wang, Jian-Ming) has three Chinese characters, i.e. “ [symbol] (i.e Wang)”, “ [symbol] (i.e. Jian)”, and “ [symbol] (i.e. Ming),” where each of them is analyzed according to its initial part and its final part of the Chinese syllable. Specifically, the phonetic notation of the Chinese character “ [symbol] (i.e. Wang)” is “ [symbol] ,” which does not have the initial part but has the final part (i.e. [symbol] ) of the Chinese syllable. The phonetic notation of the Chinese character “ [symbol] ” (i.e. Jian) is “ [symbol] ,” which has both the initial part (i.e. [symbol] ) and the final part (i.e. [symbol] ) of the Chinese syllable. Lastly, the phonetic notation of the Chinese character “ [symbol] ” (i.e. Ming) is “ [symbol] ,” which also has both the initial part (i.e. [symbol] ) and the final part (i.e. [symbol] [symbol] ) of the Chinese syllable. In general, for this embodiment, the initial part of the Chinese syllable is configured to have three states, while the final part of the Chinese syllable is configured to have six states. Thus, the Chinese character “ [symbol] ” has 6 states in its HMM speech model, the Chinese character “ [symbol] ” has 9 (3+6) states in its HMM speech model, and the Chinese character “ [symbol] ” has 9 (3+6) states in its HMM speech model. In total, the Chinese name “ [symbol] [symbol] ” has 24 (6+9+9) states in the HMM speech model corresponding to “ [symbol] ”. The above descriptions are well known by people skilled in the art. For more details, one can refer to L. R. Rabiner, “A tutorial on hidden Markov models and selected applications in speech recognition”, Proc. IEEE, Vol. 77, Issue 2, pp. 257-286, February 1989.

It should be noted that the number of states of the initial part and the final part of a Chinese syllable are not limited to 3 or 6 states. The number of states can be adjusted according to the situation. Nevertheless, the ratio of the initial part and the final part of the Chinese syllable should be 1:2 because the pronunciation of a final part is longer than that of an initial part.

After the HMM speech model has been introduced, the SVM determination model follows. An MFCC is obtained from each HMM speech model. In this embodiment, an MFCC consists of ten stages. MFCC is the feature signal of a voice in the frequency domain, which can represent different voice frequencies heard by the human ear. The SVM determination model of “ [symbol] ” has 240 (24*10) stages because “ [symbol] ” has 24 states. The SVM determination model of “ [symbol] ” has a separating hyperplane which has been trained by several training speech signals. The separating hyperplane of the SVM determination model of “ [symbol] ” can be used to determine whether the input speech signal is “ [symbol] ” or not. If the input speech signal falls into the “ [symbol] ” zone of the separating hyperplane, the input speech signal has the meaning of “ [symbol] ”.

This embodiment can determine whether the original signal is valid and use the valid original signal to train, adjust, or update the HMM speech models.

The reception module 201 is an interface to receive an original signal 200 from a user. For example, the user can input the original signal “ [symbol] , [symbol] ” (i.e. Please look for Wang, Jian-Ming, ok?) via a microphone. After that, the original signal 200 is transmitted to the second determination module 202 to determine whether the original signal 200 is a speech signal. For example, the second determination module 202 may determine whether the signal model or the frequency of the original signal 200 matches those of a speech signal. If not, the procedure ends. If so, the original signal 200 is transmitted to the feature extraction module 204.

The feature extraction module 204 retrieves a featured speech signal 205 (that is, the MFCC of “ [symbol] [symbol] ”) from the original signal 200. It should be noted that the MFCC can be replaced by an LPCC, a Cepstral, etc. In this embodiment, the speech recognition device is able to receive a continuous speech signal from the user and is able to process the expletives and irrelevant words, with an aim to recognize the keywords. The keyword extraction module 206 is used to extract the keywords correctly. In this embodiment, the filler model is used to represent the expletives and the irrelevant words, i.e. the rest of the keywords. In this embodiment, a filler model is placed in front of the keyword and another filler model is placed behind the keyword to represent the non-keywords. For example, in the speech signal “ [symbol] [symbol] ” of the above original signal 200, “ [symbol] ” (i.e. Please look for) and “ [symbol] ” (i.e. ok?) are not keywords. The above descriptions are well-known to those skilled in the art, so which are not described in details here. In summary, the keyword extraction module 206 extracts a keyword speech signal 207, that is, the MFCC of “ [symbol] ”, from the featured speech signal 205 and transmits the keyword speech signal 207 to the first determination module 208. Meanwhile, the decision module 221 decides a selection number. The decision module 221 can decide the selection number according to an input instruction of the user or decide the selection number according to a predetermined value of the system. In this embodiment, the selection number is three. The first selection module 220 receives the keyword speech signal 207, compares the keyword speech signal 207 with each of the HMM speech models in the first database 219, and selects the selection number (the selection number is three in this embodiment) of the HMM speech models with the greatest likelihood values. For example, “ [symbol] ”, “ [symbol] [symbol] ”, and “ [symbol] ” are selected because they have the greatest likelihood values. These three HMM speech models 225 are transmitted to the first determination module 208.

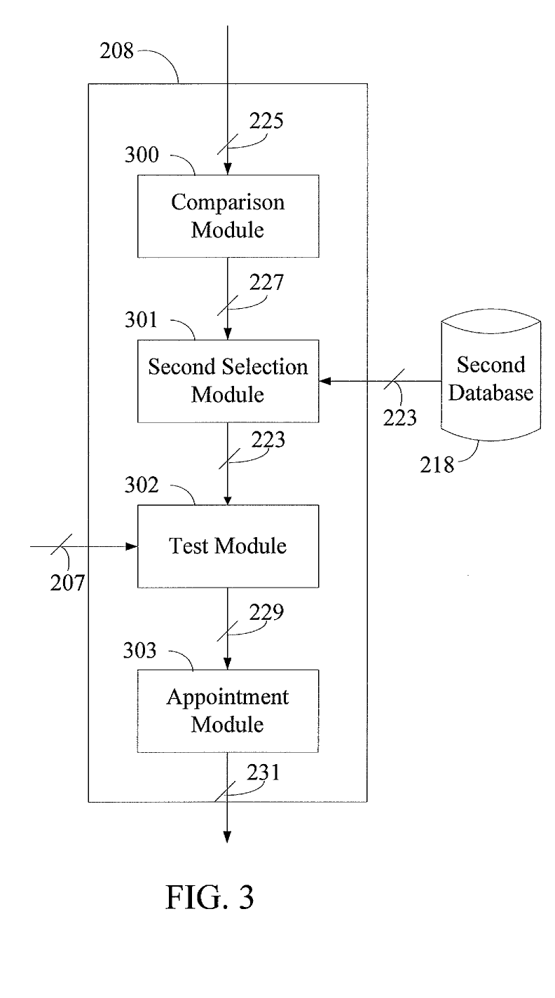

FIG. 3 is the diagram of the first determination module 208 of the first embodiment. The first determination module 208 determines whether the keyword speech signal 207 is valid. The first determination module 208 comprises a comparison module 300, a second selection module 301, a test module 302, and an appointment module 303.

The comparison module 300 stores a predetermined threshold and compares the maximal likelihood value of three HMM speech models 225 with the predetermined threshold. If the maximal likelihood value of three HMM speech models 225 are equal to or greater than the predetermined threshold, the HMM speech model with the maximal likelihood value is an appointed HMM speech model, which means the keyword speech signal 207 is valid.

If the likelihood values of three HMM speech model are smaller than the predetermined threshold, the comparison module 300 transmits a signal 277 to the second selection module 301. The second selection module 301 retrieves a corresponding SVM determination model 223 from the second database 218 according to each of the three HMM speech models 225. In other words, the second selection module 301 retrieves the SVM determination models of “ [symbol] ”, “ [symbol] ”, and “ [symbol] ” which correspond to the HMM speech models of “ [symbol] ”, “ [symbol] ”, and “ [symbol] ” respectively and transmits them to the test module 302. The test module 302 uses the three SVM determination models 223 to test whether the keyword speech signal 207 is correct. That is, the test module 302 determines which side of the separating hyperplane of each of the SVM determination model that the keyword speech signal 207 is located. If at least one test result is correct, the test module 302 transmits a signal 229 to the appointment module 303. The appointment module 303 appoints the HMM speech model with the maximal likelihood value in the HMM speech models as the appointed HMM speech model. The appoint module 303 also confirms that the keyword speech signal 207 is valid. The appointment module 303 will then transmit the information 231 to the first calculation module 210 and the second calculation module 211. For example, the test module 302 determines that the keyword speech signal 207 belongs to the correct side of the “ [symbol] ” SVM determination model, the correct side of the “ [symbol] ” SVM determination model, and the wrong side of the “ [symbol] , [symbol] ” SVM determination model. As a result, the appointment module 303 will appoint the one with the greatest likelihood value of the “ [symbol] ” and the “ [symbol] ” HMM speech models as the appointed HMM speech model.

After the first determination module 208 determines that the keyword speech signal 207 is valid, the HMM speech models, denoted as Initial_states, will be adjusted based on the keyword speech signal 207. Specifically, the first calculation module 210 calculates an adjustment weight, denoted as AD. The calculation way is described in the following. The second calculation module 211 uses the conventional HMM speech adjustment method (such as a linear regression method) to obtain a regression matrix, A, wherein the keyword speech signal 207 and the appointed HMM speech model are considered as linear regression inputs. The HMM speech models, Initial_state, can be transformed into a plurality of temporary models, denoted as Adapt_state, via the regression matrix, A (Adapt_state=A . Initial_state). Finally, the adjustment module 214 updates the original speech model according to the following equation:

AD . Adapt_state+(1−-AD) . Initial_state

To be more specifically, the first calculation module 210 uses either the frame number or the number of the keyword speech signal to calculate the adjustment weight AD. Both of them are explained in the following paragraphs.

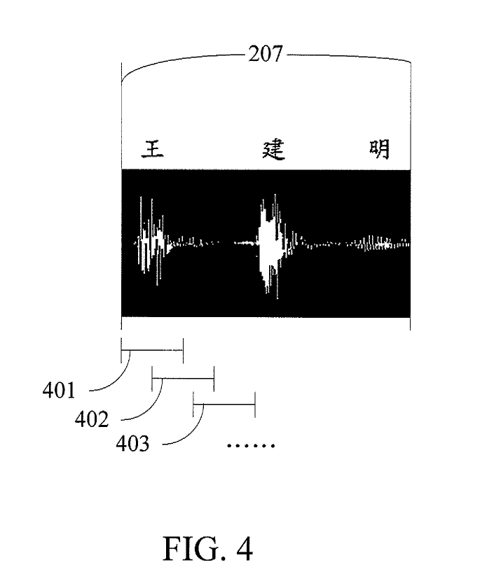

First, calculating the adjustment weight AD by the frame number is explained. The speech signal is non-periodic, so the speech signal is divided into many frames during the process of speech recognition. By dividing the speech signal into several frames, speech recognition can be achieved more efficiently. FIG. 4 is a schematic diagram of the keyword speech signal 207. The parts marked by 401, 402, and 403 are the first frame, the second frame, and the third frame, respectively, which are generated by the first calculation module 210 according to the predetermined period. In this embodiment, the frame number of the keyword speech signal 207 is 480. The first calculation module 210 will use the frame number to calculate the adjustment weight AD.

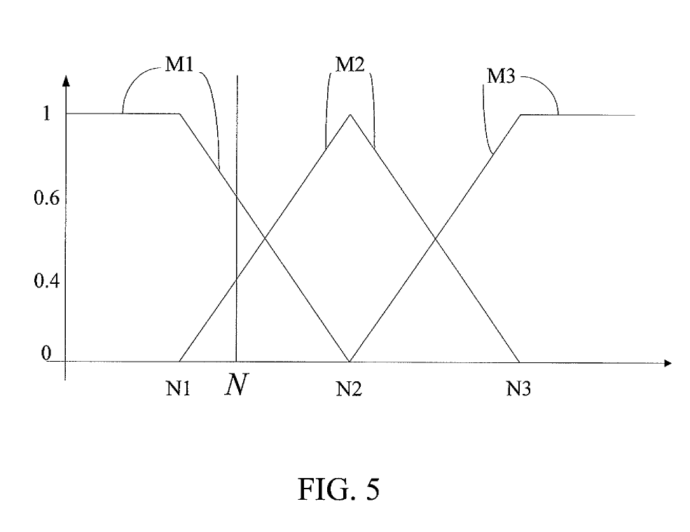

FIG. 5 illustrates the rule for the calculation of the adjustment weight AD used by the first calculation module 210, wherein the horizontal axis N represents the frame number and the vertical axis represents the weight parameter. The horizontal axis defines a first frame constant (denoted as N1), a second frame number (denoted as N2), and a third frame number (denoted as N3). In this embodiment, N1, N2, and N3 are 300, 600, and 900 respectively, and are all stored in the first calculation module 210. It should be noted these frame constants can be adjusted according to the situation and are not used to limit the scope of the invention. FIG. 5 further illustrates a first weight equation M1, a second weight equation M2, and a third weight equation M3. The weight equations are shown here:

$$M 1 ( N ) = \{ \begin{matrix}1 & N \leq N 1 \\ \frac{N 2 - N}{N 2 - N 1} & N 1 \leq N \leq N 2 \\ 0 & N \geq N 2\end{matrix} \\ M 2 ( N ) = \{ \begin{matrix}0 & N \leq N 1 or N \geq N 3 \\ \frac{N - N 1}{N 2 - N 1} & N 1 < N \leq N 2 \\ \frac{N 3 - N}{N 3 - N 2} & N 2 \leq N < N 3\end{matrix} \\ M 3 ( N ) = \{ \begin{matrix}0 & N \leq N 2 \\ \frac{N - N 2}{N 3 - N 2} & N 2 < N < N 3 \\ 1 & N \geq N 3\end{matrix}$$

The frame number, N, of the keyword speech signal 207 of the embodiment is 408. The first calculation module 210 uses the first weight equation M1, the second weight equation M2, and the third weight equation M3 to obtain M1(N)=0.4, M2(N)=0.6, and M3(N)=0.

On the other hand, the first parameter f₁(N), second parameter f₂(N), and third parameter f₃(N) are obtained according to the following linear equations:

f(N)=a₁·N+b₁,

f₂(N)=a₂·N+b₂, and

f₃(N)=a₃·N+b₃

wherein a₁, a₂, a₃, b₁, b₂, and b₃ are predetermined constants, respectively. Next, the first calculation module 210 calculates the adjustment weight AD according to the following equation:

$$\begin{matrix}AD = \frac{M 1 ( N ) \cdot {f}_{1} ( N ) + M 2 ( N ) \cdot {f}_{2} ( N ) + M 3 ( N ) \cdot {f}_{3} ( N )}{M 1 ( N ) + M 2 ( N ) + M 3 ( N )} \\ = 0.6 {f}_{1} ( N ) + 0.4 {f}_{2} ( N )\end{matrix}$$

Now, calculating the adjustment weight AD according to the number of the keyword speech signal 207 is explained. The adjustment weight (i.e. AD) is the multiplication of 0.1 and the number of the keyword speech signal 207, wherein 0.1 can be any constant and is not used to limited the scope of this invention. In this embodiment, the adjustment weight, AD, is assigned as 0.1 because there is just one keyword speech signal. If there are three keyword speech signals, the adjustment weight, AD, can be assigned a value of 0.3. After obtaining the adjustment weight, AD, the HMM speech models are updated according to the above equations. The updated HMM speech models are then stored in the first database 219.

The recognition module 216 recognizes the speech according to the updated HMM speech models hereafter. This will improve the accuracy of speech recognition by the HMM speech models due to the dynamic updates. The recognition module 216 can use the conventional technique to recognize speech and thus, is not repeated here.

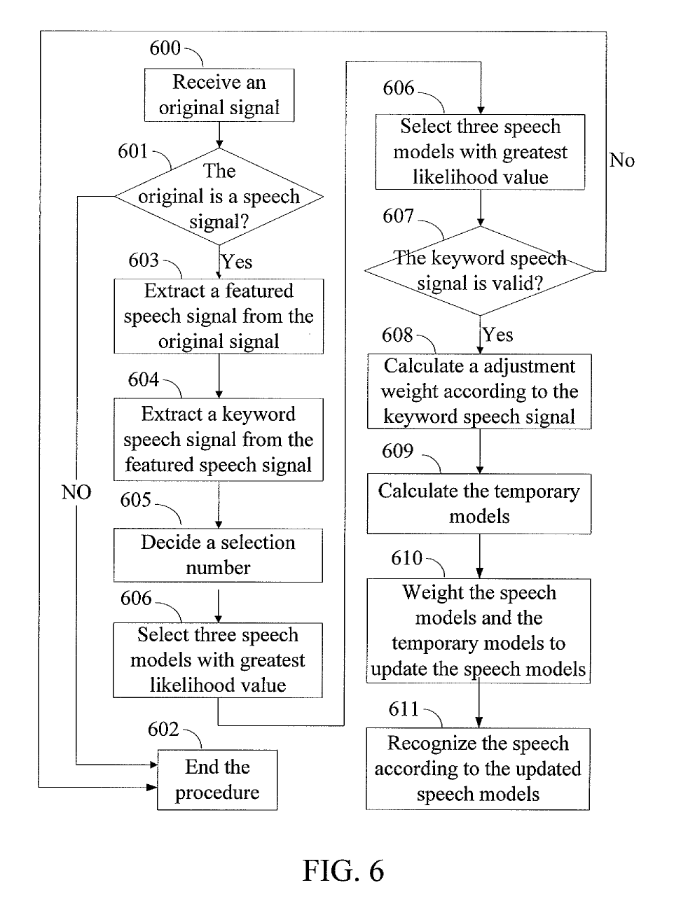

A second embodiment of the invention is shown in FIG. 6, which shows a speech recognition method used in the speech recognition device of the first embodiment. Specifically, the method of the second embodiment can be realized via an application program for the modules of the speech recognition device. The method of the second embodiment can determine whether an original signal is valid and use the valid original signal to train, adjust, or update the HMM speech model.

At first, step 600 is executed to receive an original signal from a user. For example, if a user inputs the speech signal of “ [symbol] , [symbol] ” (i.e. Please look for Wang, Jian-Ming, ok?) via a microphone, the original signal is “ [symbol] , [symbol] ”. Next, step 601 is executed to determine whether the original signal is a speech signal. Step 601 may make the determination by comparing whether the signal model or the frequency of the original signal matches those of speech signals. If not, step 602 is executed to end the procedure of adjusting the models. If so, step 603 is executed.

In step 603, the method extracts a featured speech signal (that is, MFCC of “ [symbol] [symbol] ”) from the original signal. It should be noted that MFCC can be replaced by LPCC, Cepstral, or the like. Next, step 604 is executed to extract a keyword speech signal from the featured speech signal, that is, the MFCC of “ [symbol] ”. The conventional technique for extracting the keyword speech signal can be adopted and thus, is not repeated here.

Next, step 605 is executed, in which the method decides a selection number. To be more specifically, the selection number may be inputted by the user or be a predetermined value of a system. In this embodiment, the selection number is three. After that, step 606 is executed to select the selection number (that is three) of the HMM speech models with the greatest likelihood values by firstly receiving the keyword speech signal and then comparing the keyword speech signal with each of the HMM speech models in a first database. For example, “ [symbol] ”, “ [symbol] ”, and “ [symbol] ” are selected because they have the greatest likelihood values. The content of the first database is the same as the first database in the first embodiment, so it is not repeated here.

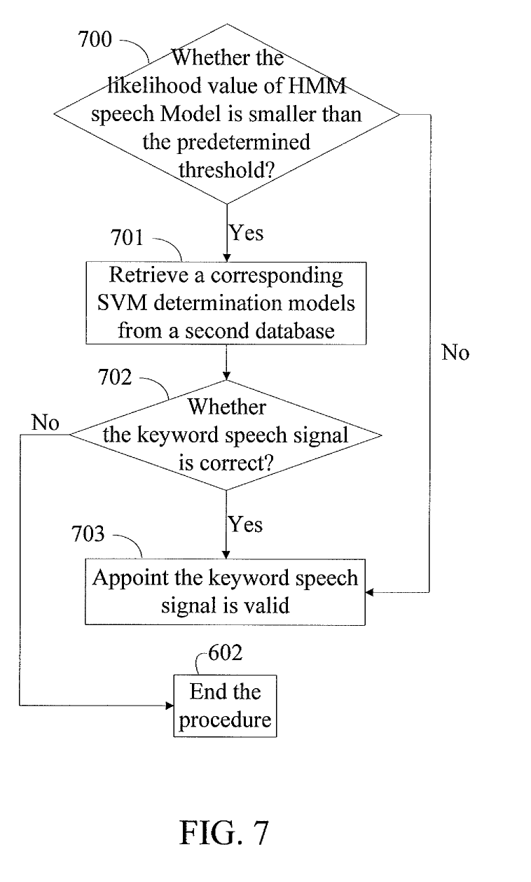

After that, step 607 is executed to determine whether the keyword speech signal is valid by the steps shown in FIG. 7. In step 700, the method compares the maximal likelihood value of the three HMM speech models with a predetermined threshold. If the likelihood values of the three HMM speech models are smaller than the predetermined threshold, step 701 is executed to retrieve the corresponding SVM determination model from a second database according to each of the three HMM speech models. The content of the second database is the same to the second database in the first embodiment, so it is not repeated here. In other words, the SVM determination models of “ [symbol] ”, “ [symbol] ”, and “ [symbol] ” are retrieved to correspond to the HMM speech models of “ [symbol] ”, “ [symbol] ”, and “ [symbol] ” respectively. After that, step 702 is executed to use the three SVM determination models to test whether the keyword speech signal is correct. That is, step 702 determines which side of the hyperplane of each of the SVM determination model that the keyword speech signal is located. If at least one of the test results is correct, step 703 is executed to appoint the HMM speech model with the maximal likelihood value in the HMM speech models as the appointed HMM speech model and confirms that the keyword speech signal is valid. The application program then enables the appointment module to transmit the information to both the first and second calculation module. If the test module determines that the keyword speech signal is incorrect, step 602 will be executed to end the procedure. If the maximal likelihood value of three HMM speech models are equal to or greater than the predetermined threshold, step 703 is executed. If it is no in step 700, the method executes step 703 directly.

After step 703, step 608 is executed to calculate an adjustment weight, AD. The details of the calculation of the adjustment weight AD is similar to those described in the first embodiment, so which is not repeated here. Next, step 609 is executed to calculate a plurality of temporary models by using the conventional HMM speech adjustment methods (such as linear regression), wherein the keyword speech signal and the appointed HMM speech model are considered as the inputs of the linear regression. To be more specific, the temporary models (denoted as Adapt_{‘}state) is derived by transforming the HMM speech models (denoted as Initial_state) via a regression matrix A representing the linear regression. That is, Adapt_state=A . Initial_state. Finally, step 610 is executed to update the original speech model according to the following equation:

AD . Adapt_state+(1−AD) . Initial_state

The updated HMM speech models are then stored in the first database. Finally, step 611 is executed to recognize new speech signals according to the updated HMM speech models. This will improve the accuracy of speech recognition by the HMM speech models since it is dynamically updated.

Each of the aforementioned methods can use a computer readable medium for storing a computer program to execute the aforementioned steps. The computer readable medium can be a floppy disk, a hard disk, an optical disc, a flash disk, a tape, a database accessible from a network or a storage medium with the same functionality that can be easily thought by people skilled in the art.

According to the above descriptions, the invention is able to determine whether an input signal is a speech signal and further automatically selects the more accurate speech signal to train the speech models. In addition, the invention can dynamically determine the adjustment weight according to the number and quality of the speech signal for adjusting the speech model. The invention can avoid problems of conventional techniques which could not adapt to a situation in which the quality and number of speech signals were not good enough to dynamically adjust the HMM models.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A speech recognition device, comprising:
a first determination module for deciding an appointed speech model according to a keyword speech signal and for determining whether the keyword speech signal is valid, wherein the appointed speech model is one of a plurality of speech models stored in a first database;
a first calculation module for calculating an adjustment weight according to the keyword speech signal if the keyword speech signal is valid;
a second calculation module for calculating a plurality of temporary models according to the keyword speech signal, the appointed speech signal, and the speech models if the keyword speech signal is valid;
an adjustment module for weighting the speech models and the temporary models to update the speech models according to the adjustment weight; and
a recognition module for recognizing a new speech signal according to the updated speech models.

2. The speech recognition device of claim 1, further comprising:
a reception module for receiving an original signal;
a second determination module for determining whether the original signal is a speech signal; and
a feature extraction module for extracting a featured speech signal from the original signal if the original signal is the speech signal.

3. The speech recognition device of claim 2, further comprising:
a keyword extraction module for extracting the keyword speech signal from the featured speech signal.

4. The speech recognition device of claim 1, further comprising:
a decision module for deciding a selection number; and
a first selection module for comparing the keyword speech signal with each of the speech models to decide a likelihood value for each of the speech models and for selecting the first selection number of the speech models with the greatest likelihood values as the selected models;
wherein the likelihood values is calculated according to the corresponding speech models and the keyword speech signal and the first determination module determines whether the keyword speech signal is valid according to the selected models.

5. The speech recognition device of claim 4, connected to a second database with a plurality of determination models, the first determination module further comprising:
a comparison module for comparing the maximal likelihood value of the selected models with a predetermined threshold;
a second selection module for selecting a corresponding determination model for each of the selected models from the second database if the maximal likelihood value is smaller than the predetermined threshold;
a test module for testing whether the keyword speech signal is correct to derive a testing result according to each of the determination models; and
an appointment module for appointing the speech model which has the maximal likelihood value and which corresponds to one of the determination models with the correct result as the appointed speech model if at least one of the testing results is correct, and for confirming the keyword speech signal is valid.

6. The speech recognition device of claim 1, wherein the first calculation module further calculates a frame number of the keyword speech signal and utilizes the frame number to calculate the adjustment weight.

7. The speech recognition device of claim 6, wherein the first calculation module obtains a first weight parameter M1(N) by substituting the frame number to a first weight equation, a second weight parameter M2(M) by substituting the frame number to a second weight equation, a third weight parameter M3(N) by substituting the frame number to a third weight equation, a first parameter f₁(N) by substituting the frame number to a first linear equation, a second parameter f₂(N) by substituting the frame number to a second linear equation, and a third parameter f₃(N) by substituting the frame number to a third linear equation and the first calculation module calculates the adjustment weight AD according to the following equation:
$$AD = \frac{M 1 ( N ) \cdot {f}_{1} ( N ) + M 2 ( N ) \cdot {f}_{2} ( N ) + M 3 ( N ) \cdot {f}_{3} ( N )}{M 1 ( N ) + M 2 ( N ) + M 3 ( N )}$$
wherein N represents the frame number.

8. The speech recognition device of claim 7, wherein the adjustment module weights the speech models and the temporary models to update the speech models according to the following equation:
AD·Adapt_state+(1−AD)·Initial_state
wherein Adapt_state represents the temporary models and Initial_state represents the speech models corresponding to Adapt_state.

9. The speech recognition device of claim 1, wherein the first calculation module further calculates the adjustment weight according to a count of the keyword speech signal.

10. The speech recognition device of claim 9, wherein the first calculation module derives the adjustment weight by multiplying the count with a predetermined parameter.

11. A speech recognition method, comprising the following steps of:
deciding an appointed speech model according to a keyword speech signal;
determining whether the keyword speech signal is valid, wherein the appointed speech model is one of a plurality of speech models stored in a first database;
calculating an adjustment weight according to the keyword speech signal if the keyword speech signal is valid;
calculating a plurality of temporary models according to the keyword speech signal, the appointed speech signal, and the speech models if the keyword speech signal is valid;
weighting the speech models and the temporary models to update the speech models according to the adjustment weight; and
recognizing a new speech signal according to the updated speech models.

12. The speech recognition method of claim 11, further comprising the following steps of:
receiving an original signal;
determining whether the original signal is a speech signal; and
extracting a featured speech signal from the original signal if the original signal is the speech signal.

13. The speech recognition method of claim 12, further comprising the following step of:
extracting the keyword speech signal from the featured speech signal.

14. The speech recognition method of claim 11, further comprising the following steps of:
deciding a selection number; and
comparing the keyword speech signal with each of the speech models to decide a likelihood value for each of the speech models;
selecting the first selection number of the speech models with the greatest likelihood value as the selected models;
wherein the likelihood values is calculated according to the corresponding speech models and the keyword speech signal and the step of determining whether the keyword speech signal is valid makes the determination according to the selected models.

15. The speech recognition method of claim 14, wherein the step of calculating the adjustment weight comprises the following steps of:
comparing the maximal likelihood value of the selected models with a predetermined threshold;
selecting a corresponding determination model for each of the selected models from the second database if the maximal likelihood value is smaller than the predetermined threshold;
testing whether the keyword speech signal is correct to derive a testing result according to each of the determination models;
appointing the speech model which has the maximal likelihood value and which corresponds to one of the determination models with the correct result as the appointed speech model if at least one of the testing results is correct; and
confirming the keyword speech signal is correct.

16. The speech recognition method of claim 11, wherein the step of calculating the adjustment weight comprises the following step of:
calculating a frame number of the keyword speech signal;
wherein the frame number is utilized to calculate the adjustment weight.

17. The speech recognition method of claim 16, wherein the step of calculating the adjustment weight obtains a first weight parameter M1(N) by substituting the frame number to a first weight equation, a second weight parameter M2(N) by substituting the frame number to a second weight equation, a third weight parameter M3(N) by substituting the frame number to a third weight equation, a first parameter f₁(N) by substituting the frame number to a first linear equation, a second parameter f₂(N) by substituting the frame number to a second linear equation, and a third parameter f₃(N) by substituting the frame number to a third linear equation, and calculates the adjustment weight AD according to the following equation:
$$AD = \frac{M 1 ( N ) \cdot {f}_{1} ( N ) + M 2 ( N ) \cdot {f}_{2} ( N ) + M 3 ( N ) \cdot {f}_{3} ( N )}{M 1 ( N ) + M 2 ( N ) + M 3 ( N )}$$
wherein N represents the frame number.

18. The speech recognition method of claim 17, wherein the step of weighting the speech models and the temporary models weights the speech models and the temporary models to update the speech models according to the following equation:
AD˜Adapt_state+(1−AD)·Initial_state
wherein Adapt_state represents the temporary models and Initial_state represents the speech models corresponding to Adapt_state.

19. The speech recognition method of claim 11, wherein the step of calculating the adjustment weight according to the keyword speech signal further calculates the adjustment weight according to a count of the keyword speech signal.

20. The speech recognition method of claim 19, wherein the step of calculating the adjustment weight according to the keyword speech signal derives the adjustment weight by multiplying the count with a predetermined parameter.

21. A computer readable medium, storing an application program to execute a method for speech recognition, the method comprising the steps of:
deciding an appointed speech model according to a keyword speech signal;
determining whether the keyword speech signal is valid, wherein the appointed speech model is one of a plurality of speech models stored in a first database;
calculating an adjustment weight according to the keyword speech signal if the keyword speech signal is valid;
calculating a plurality of temporary models according to the keyword speech signal, the appointed speech signal, and the speech models if the keyword speech signal being valid;
weighting the speech models and the temporary models to update the speech models according to the adjustment weight; and
recognizing a new speech signal according to the updated speech models.

22. The computer readable medium of claim 21, further comprising the following steps of:
receiving an original signal;
determining whether the original signal is a speech signal; and
extracting a featured speech signal from the original signal if the original signal is the speech signal.

23. The computer readable medium of claim 22, further comprising the following step of:
extracting the keyword speech signal from the featured speech signal.

24. The computer readable medium of claim 21, further comprising the following steps of:
deciding a selection number; and
comparing the keyword speech signal with each of the speech models to decide a likelihood value for each of the speech models;
selecting the first selection number of the speech models with the greatest likelihood value as the selected models;
wherein the likelihood values is calculated according to the corresponding speech models and the keyword speech signal and the step of determining whether the keyword speech signal is valid makes the determination according to the selected models.

25. The computer readable medium of claim 24, wherein the step of calculating the adjustment weight comprises the following steps of:
comparing the maximal likelihood value of the selected models with a predetermined threshold;
selecting a corresponding determination model for each of the selected models from the second database if the maximal likelihood value is smaller than the predetermined threshold;
testing whether the keyword speech signal is correct to derive a testing result according to each of the determination models;
appointing the speech model which has the maximal likelihood value and which corresponds to one of the determination models with the correct result as the appointed speech model if at least one of the testing results is correct; and
confirming the keyword speech signal is correct.

26. The computer readable medium of claim 21, wherein the step of calculating the adjustment weight comprises the following step of:
calculating a frame number of the keyword speech signal;
wherein the frame number is utilized to calculate the adjustment weight.

27. The computer readable medium of claim 26, wherein the step of calculating the adjustment weight obtains a first weight parameter M1(N) by substituting the frame number to a first weight equation, a second weight parameter M2(N) by substituting the frame number to a second weight equation, a third weight parameter M3(N) by substituting the frame number to a third weight equation, a first parameter f₁(N) by substituting the frame number to a first linear equation, a second parameter f₂(N) by substituting the frame number to a second linear equation, and a third parameter f₃(N) by substituting the frame number to a third linear equation, and calculates the adjustment weight AD according to the following equation:
$$AD = \frac{M 1 ( N ) \cdot {f}_{1} ( N ) + M 2 ( N ) \cdot {f}_{2} ( N ) + M 3 ( N ) \cdot {f}_{3} ( N )}{M 1 ( N ) + M 2 ( N ) + M 3 ( N )}$$
wherein N represents the frame number.

28. The computer readable medium of claim 27, wherein the step of weighting the speech models and the temporary models weights the speech models and the temporary models to update the speech models according to the following equation:
AD·Adapt_state+(1−AD)·Initial_state
wherein Adapt_state represents the temporary models and Initial_state represents the speech models corresponding to Adapt state.

29. The computer readable medium of claim 21, wherein the step of calculating the adjustment weight according to the keyword speech signal further calculates the adjustment weight according to a count of the keyword speech signal.

30. The computer readable medium of claim 29, wherein the step of calculating the adjustment weight according to the keyword speech signal derives the adjustment weight by multiplying the count with a predetermined parameter.
